(19) United States
(12) Patent Application Publication
(10) Pub. No.: US 2016/0201441 A1
(43) Pub. Date: Jul. 14, 2016

(54) SELECTION OF PROPPING AGENT FOR HETEROGENEOUS PROPPANT PLACEMENT APPLICATIONS

(71) Applicant: SCHLUMBERGER TECHNOLOGY CORPORATION, Sugar Land, TX (US)

(72) Inventors: Oleg Medvedev, Kyiv (UA); Anatoly Vladimirovich Medvedev, Moscow (RU)

(21) Appl. No.: 14/592,527

(22) Filed: Jan. 8, 2015

(51) Int. Cl. E21B 43/267; C09K 8/80

(52) U.S. Cl. CPC E21B 43/267; C09K 8/80

(57) ABSTRACT

A method of proppant placement within a fracture may include injecting a proppant-laden fluid through the wellbore into the fracture under pressure to form at least one proppant pillar within the fracture, the proppant-laden fluid comprising a non-spherical proppant ossessing at least some roughness or at least some roughness and angularity; wherein upon removal of the pressure the diameter of the proppant pillar increases by less than about 100 percent of the initial diameter.

### BACKGROUND

Hydrocarbons (oil, natural gas, etc.) are obtained from a subterranean geologic formation (i.e., a “reservoir”) by drilling a well that penetrates the hydrocarbon-bearing formation. The well provides a partial flowpath for the hydrocarbon to reach the surface. In order for the hydrocarbon to be “produced,” that is travel from the formation to the wellbore (and ultimately to the surface), there must be a sufficiently unimpeded flowpath from the formation to the wellbore.

Hydraulic fracturing is a primary tool for improving well productivity by creating or extending fractures or channels from the wellbore to the reservoir. Pumping of propping granules, or proppants, during the hydraulic fracturing of oil and gas containing earth formations may enhance the hydrocarbon production capabilities of the earth formation. Hydraulic fracturing injects a viscous fluid into an oil and gas bearing earth formation under high pressure, which results in the creation or growth of fractures within the earth formation. These fractures serve as conduits for the flow of hydrocarbons trapped within the formation to the wellbore. To keep the fractures open and capable of supporting the flow of hydrocarbons to the wellbore, proppants are delivered to the fractures within the formation by a carrier fluid and fill the fracture with a proppant pack that is strong enough to resist closure of the fracture due to formation pressure and also permeable for the flow of the fluids within the formation.

Often the sphericity and roundness of the proppant, as well as the uniformity of their size and shape are considered highly important properties for their performance in fracture stabilization. Specifically, such properties are conventionally believed to be important for the achieving a permeable proppant pack that permits the flow of hydrocarbon fluids to flow through the fracture and proppant pack.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of proppant placement within a fracture that includes, injecting a proppant-laden fluid through the wellbore into the fracture under pressure to form at least one proppant pillar within the fracture, the proppant-laden fluid comprising a non-spherical proppant ossessing at least some roughness or at least some roughness and angularity; wherein upon removal of the pressure the diameter of the proppant pillar increases by less than about 100 percent of the initial diameter.

In another aspect, embodiments disclosed herein relate to a fluid for use in hydraulic fracturing that includes a carrier fluid; and a non-spherical proppant material that possesses at least some roughness or at least some roughness and angularity.

Other aspects and advantages of the claimed subject matter will be apparent from the following description and the appended claims.

### BRIEF DESCRIPTION OF DRAWINGS

FIG. 1-1 is a schematic view of a fracture during a hydraulic fracturing process.

FIG. 1-2 is a schematic view of a fracture after ceasing the injection of fracturing fluids and the pressure within the wellbore and subterranean zone is released.

FIG. 2-1 is a schematic view of the initial period of fracture closure.

FIG. 2-2 is a schematic view of a period of fracture closure after the period shown in FIG. 2-1.

FIG. 2-3 is a schematic view of a period of fracture closure after the period shown in FIG. 2-2.

FIG. 2-4 is a schematic view of a period of fracture closure after the period shown in FIG. 2-3.

FIG. 3 is a Krumbein chart.

FIG. 4 shows several proppants with different friction coefficients after being subjected to a load.

FIG. 5 shows the results of a squashing experiment using a HARP-proppant mixture.

### DETAILED DESCRIPTION

In one aspect, embodiments disclosed herein relate to the use of an optimized propping agent or proppant to increase the conductivity of fractures created or extended by a hydraulic fracturing processes. Specifically, embodiments disclosed herein endeavor to improve the performance and stability of fracturing operations using heterogeneous proppant placement by selecting propping agents which are more prompt to bridging or arching during compaction, resulting in thicker proppant structures and wider channels within the fracture and overall higher fracture conductivity. In other embodiments, methods and fluids disclosed herein may also improve the performance and stability of fracturing operations using conventional proppant placement, where proppant injection into the fracture is continuous rather than using alternating stages of substantially proppant-free and proppant laden fracturing fluids.

In general, hydraulic fracturing treatment methods are considered to have several distinct stages. During the first stage, a hydraulic fracturing fluid is injected through a wellbore into a subterranean formation at high rates and pressures. Upon reaching a threshold value, the pressure causes the formation strata or rock to crack and fracture. As the injection of fracturing fluid continues, the fractures and cracks propagate further into the formation. During a second stage, proppant is admixed into the fracturing fluid and transported throughout the hydraulic fractures. In this way, proppant may be deposited throughout the length of the created fractures and serves to mechanically prevent the fracture from closing after the injection, and the pressure supplied thereby, stops.

In some embodiments, the placement of proppant within the fractures is accomplished by pumping alternating stages of substantially proppant-free and proppant-laden fracturing fluid through a wellbore and into the fracture network. The alternating proppant stages may be created by appropriate surface equipment prior to their delivery downhole. Hydrualic fracturing processes including the injection of alternating stages of fracturing fluid substantially free of proppant and proppant-laden fracturing fluid may create heterogeneous proppant structures and a system of substantially open channels within the fracture network. The heterogeneously placed proppant structures and the system of open channels within the fracture formed thereby may allow for a high fracture conductivity and improved production of hydrocarbons from the formation.

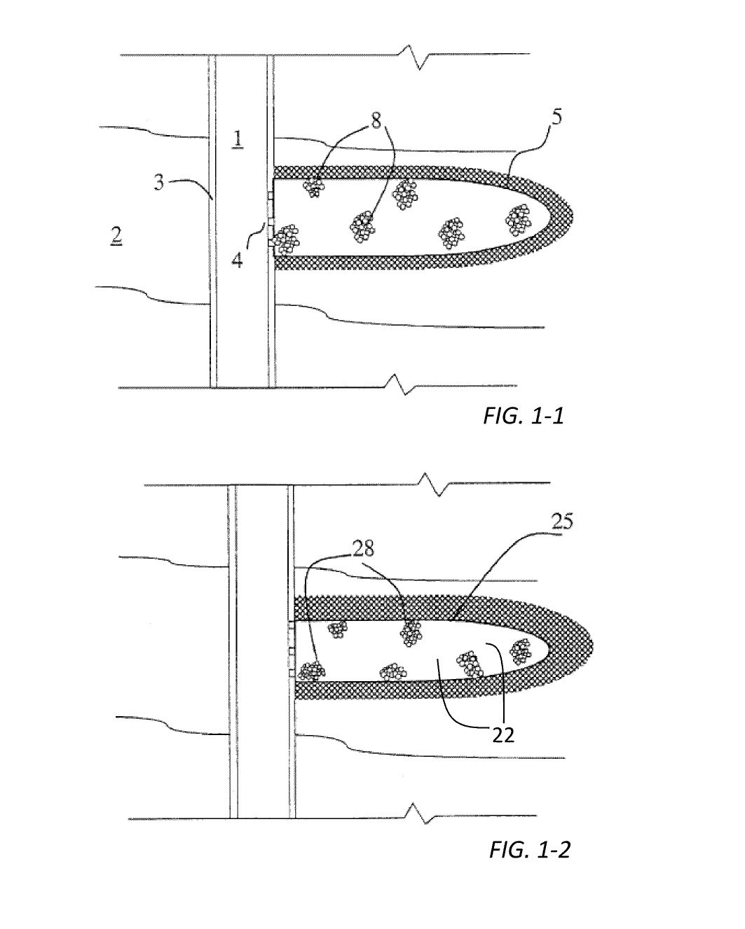

FIG. 1-1 is a schematic view of a fracture during a hydraulic fracturing process using alternating stages of fracturing fluid substantially free of proppant and proppant-laden fracturing fluid. A wellbore 1, drilled through a subterranean zone 2 that contains hydrocarbons, is cased and a cement sheath 3 is placed in the annulus between the casing and the wellbore walls. Perforations 4 are created to establish a connection between the subterranean zone 2 and the wellbore 1. A fracturing fluid is pumped downhole at a rate and pressure sufficient to form a fracture 5 (side view). Due to the alternating stages of fracturing fluid substantially free of proppant and proppant-laden fracturing fluid, clusters of proppant 8 are heterogeneously spread out along a large fraction (if not all) of the fracture length.

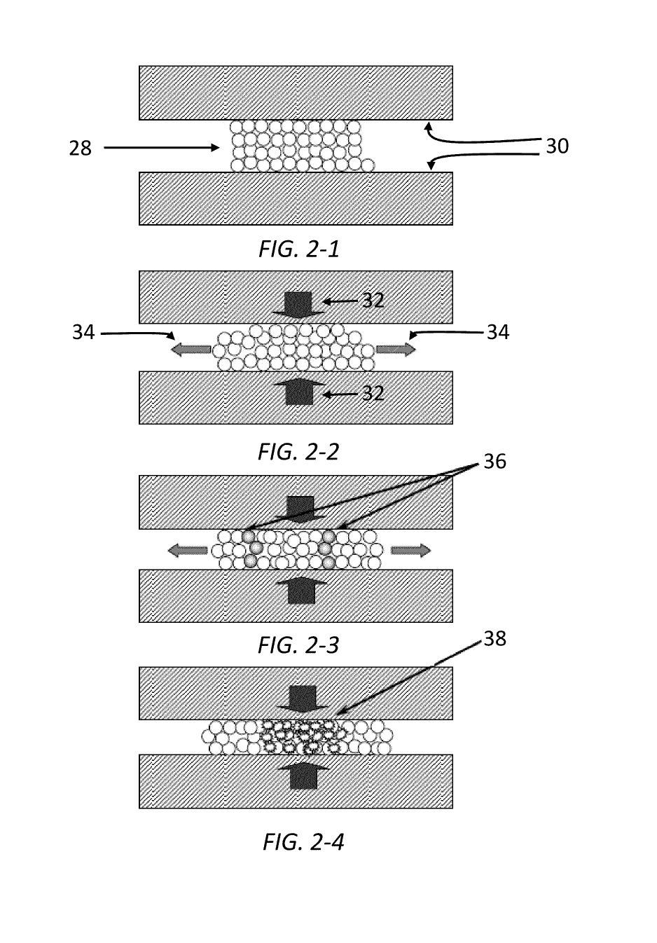

FIG. 1-2 is a schematic view of a fracture after ceasing the injection of fracturing fluids and the pressure within the wellbore and subterranean zone is released. Once the pressure is released, the fracture 25 shrinks both in length and height, slightly packing down the proppant clusters 28 with the proppant clusters remaining spread out along the fracture. The area of the fracture not occupied by the proppant clusters 28 forms a system of open channels 23 within the fracture that are conductive for the production of any hydrocarbons that may be released into the fracture from the subterranean zone.

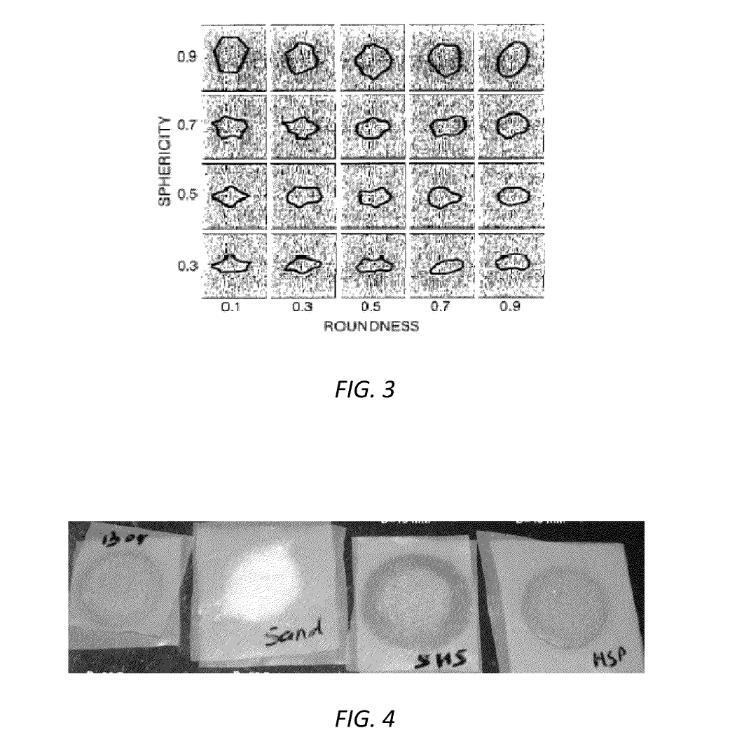

The release of pressure may also be referred to as fracture closure, and fracture closure is the stage when the channel network is formed as the the proppant clusters are converted to proppant pillars that serve to resist complete fracture closure as the pressure of the formation naturally attempts to close the fracture. Fracture closure is schematically illustrated in FIGS. 2-1 to 2-4. FIG. 2-1 shows the initial period of fracture closure where the proppant cluster or pillar 28 becomes more concentrated due to fluid leak off into the formation. At a certain point during the fluid leak off the proppant cluster or pillar 28 contacts the fracture walls 30. FIG. 2-2 shows that the contact with the fracture walls and the pressure 32 delivered to the proppant pillar by the fracture closure initiates proppant flow 34 away from the walls. FIG. 2-3 shows that the pressure induced proppant flow 34 increases the diameter of the proppant pillar 28 up until the point where a proppant arch or bridge 36 is formed, which stabilizes the flow of the proppant pillar 28. FIG. 2-4 shows that after the stabilization of flow via the formation of an arch or bridge 36 in the proppant pillar, the width change of the proppant pillar is negligible and occurs only because of any proppant crushing and compaction 38 that may occur under the pressure of the formation.

In some embodiments, the extent of the flow of the proppant pillars may be influenced by the selection of a specialized proppant material. Proppant pillars that have smaller outward flow under the pressure of fracture closure, and thus smaller pillar diameters and greater pillar thicknesses, as measured by their extension radially within the fracture and material thickness between the walls of the fracture, respectively, lead to a channel system with a more open and conductive geometry within the fracture network. The selection of proppant materials for fracturing methods using heterogeneous proppant placement may benefit from proppant materials that are more prompt to bridging or arching during fracture closure.

In some embodiments, proppant materials possessing at least some roughness and/or angularity may lead to early bridging and arch formation. It is believed that the roughness and angularity facilitates bridging and arch formation due the increased possibility for the rough and angular proppants to interlock and otherwise resist flow past one another under the pressure of fracture closure. Early bridging and arch formation may create thicker proppant pillars, and as a result wider channels and higher fracture conductivity. Proppant materials possessing at least some degree of roughness and/or angularity deviate substantially in shape from the relatively uniform proppant materials possessing high sphericity and roundness, which are conventionally chosen to prop fractures. In some embodiments, proppant materials possessing at least some roughness and/or angularity may allow for, upon removal of the injection pressure during the fracturing operation, the diameter of the proppant pillar diameter to increase by less than about 100 percent, 95 percent, 90 percent, 85 percent, 80 percent, 75 percent, 70 percent, 65 percent, 60 percent, or 55 percent of the initial pillar diameter.

Herein, the sphericity of a particle is defined as the ratio of the diameter of a sphere of equal volume to the particle to the diameter of a circumscribing sphere of the particle. Herein, the roundness of a particle is defined as the radius of curvature of the most convex part of the particle to the mean radius of the particle. FIG. 3 is a Krumbein chart, showing the widely accepted nomenclature for classifying particles by way of their sphericity and roundness. Conventionally used proppant materials have sphericity and roundness values according to the Krumbein chart of at least, and sometimes in excess of, 0.8. Thus, conventional proppant materials are highly spherical and round and do not lead to prompt bridging and arch formation within a fracture because of their ability to easily slide and reorganize around their largely smooth and rounded surfaces. In some embodiments of the present disclosure, a portion of or substantially all of the proppant may have a sphericity less than about 0.8 or 0.7. In some embodiments, a portion of or substantially all of the proppant may have a roundness less than about 0.8 or 0.7. In yet other embodiments, substantially all of the proppant materials may have a sphericity and roundness less than about 0.7. The proppants encompassed by the present application contain the requisite surface roughness and angularity so that arch formation and bridging are prompt under the pressure of the fracture owing to their relatively difficult maneuverability in comparison to the highly spherical and round conventional proppant materials.

Further, proppants that have sphericity and roundness values according to the above may also possess higher angles of repose in comparison to proppants that have higher values for sphericity and roundess. The angle of repose of a granular material is the steepest angle of descent relative to the horizontal plane to which a material can be piled without slumping. At this angle, the material on the slope face is on the verge of sliding. The angle of repose may range from 0° to 90° and smooth, rounded proppant grains cannot be piled as steeply, or to as high of an angle, as can rough, interlocking sands. Basically, the angle of repose of a granular material is a parameter which effectively considers both roundness and sphericity, as well as material type, surface treatment, etc. In some embodiments, the angle of repose for at least some of the proppant materials may be greater than about 45°, or greater than about 40° or greater than about 35°, or greater than about 30°.

In some embodiments, the proppant materials may be sieved to achieve a particular particle size distribution and uniformity. Two sieves may be utilized, with the material that passes through the larger mesh size sieve and is collected on the smaller mesh size sieve being used as proppant materials. For example, using screens with Standard U.S. Sieve Sizes of 10/14 the proppant materials collected would pass through the No. 10 screen with a 2000 μm sieve size and be collected on the No. 14 screen with a 1410 μm sieve size. Thus, the proppant materials will have a particle size between 1410 μm and 2000 μm. Screens with Standard U.S. Sieve Sizes of 12/18, 16/20, 16/30, 20/40, 30/50, and 40/70 may be used to separate proppant materials with size ranges between 1000 μm to 1680 μm, 841 μm to 1190 μm, 595 μm to 1190 μm, 420 μm to 841 μm, 297 μm to 595 μm and 210 μm to 420 μm, respectively.

As used herein, a coefficieint of uniformity may be defined as the ratio of the maximum size of the proppant particles to the minimum size of the proppant particles, i.e., MAX Size/MIN Size. Using the typical proppant screens listed above, it can be seen that proppant materials that are sieved in the conventional way typically have a coefficient of uniformity of about 2 or less, indicating the relative uniformity of the proppant materials. However, in some embodiments according to the heterogeneous proppant placement methods of this disclosure, the coefficient of uniformity of the proppant materials used may be above about 2.25 in some embodiments, above about 2.5 in some embodiments, above about 3 in some embodiment, and above about 3.5 in some embodiments. There exists no limit on the minimum size of the proppant particles which may be used, however, the maximum size of the proppant particles may be up to about 4.5 mm.

Any proppant can be used, provided that it is compatible with the aforementioned size and shape limitations. Such proppants can be natural or synthetic, coated, or contain chemicals; more than one can be used sequentially or in mixtures of different sizes or different materials. Proppants in the same or different wells or treatments can be the same material and/or the same size as one another and the term “proppant” is intended to include gravel in this discussion. Proppant may be selected based on the rock strength, injection pressures, types of injection fluids, or even completion design. Preferably, the proppant materials include, but are not limited to, sand, sintered bauxite, glass beads, ceramic materials, naturally occurring materials, or similar materials. In some embodiments, at least a portion of the proppant may be High Aspect Ratio Proppant (HARP), which is a proppant that has a single dimension that is much larger than the other dimensions. For example, HARP may be particles that are elongated and have an aspect ratio of less than about 25. In some embodiments, the minimum aspect ratio value may be about 2, while in other embodiments, the minimum aspect ratio value may be about 5. A more specific example of a HARP may be appropriately sized cuts of metal wire having an aspect ratio of less than about 25. While the proppant material used may be substantially all proppants having at least some angularity and roughness, proppant mixtures of highly spherical and rounded proppants (conventional) with proppants having at least some angularity and roughness, as described above, are also encompassed by this application. In some embodiments, a proppant mixture may have a ratio of conventional proppant to proppants with at least some angularity and roughness of at least about 5:1, or at least about 2:1, or at least about 1:1, or at least 1:2, or at least 1:3, or at least 1:4 by weight. In some embodiments, at least a portion of the proppant may fragment or be crushed at stresses lower than the in-situ stress of the formation. This crushing or stressing may serve to increase bridging and arching in the proppant pillar during fracture closure.

Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc, some nonlimiting examples of which are proppants made of walnut hulls impregnated and encapsulated with resins.

In one or more embodiments, a chemical or physical process may be used to restrict the particles from separating when acted upon by an external force or to increase the adhesion of proppant materials to each other. In some embodiments, materials such as fibrous materials, fibrous bundles, or deformable materials may be used to restrict the motion of the proppant and keep a proppant cluster or pillar substantially intact. In the cases of fibers, it is believed that the fibers become concentrated into a mat or other three-dimensional framework, which holds the proppant thereby limiting its flowback during production. Additionally, fibers contribute to prevent fines migration and consequently, a reduction of the channel system and fracture network conductivity. The fibers may be deformable metal fibers, while the deformable materials may be polymer particles.

In some embodiments, the proppant materials may be coated with a composition that increases inter-proppant friction and thereby proppant adhesion. For instance, the proppant may be coated with a curable resin that is activated under downhole conditions, a pre-cured resin coated on the proppant, or a combination of curable and pre-cured (sold as partially cured) resin coated on the proppant. Other suitable coatings may comprise cured versions of hide glue or varnish, or one or more resins such as phenolic, urea-formaldehyde, melamine-formaldehyde, urethane, epoxy, and acrylic resins. Phenolic resins include those of the phenol-aldehyde type. Suitable coatings include thermally curable resins, including phenolic resins, urea-aldehyde resins, urethane resins, melamine resins, epoxy resins, and alkyd resins. It is believed that an increase in inter-proppant friction may facilitate the desired faster bridging and arching of the proppant materials during fracture closure. In contrast to conventional proppant placement during hydraulic fracturing processes, the permeability of the proppant cluster or pillar is not a critical parameter when utilizing heterogeneous proppant placement as the open channels provide the primary means for production flow.

In some embodiments, a hydraulic fracturing treatment includes pumping a proppant-free viscous fluid, or pad, usually water with some fluid additives to generate high viscosity, into a well faster than the fluid can escape into the formation so that the pressure rises and the rock breaks, creating artificial fractures and/or enlarging existing fractures. Then, a propping agent, or mixture of propping agents, such as those described above may be added to the fluid to form a slurry that is pumped into the fracture to prevent it from closing when the pumping pressure is released. In some embodiments, the total amount of proppant added to the form the slurry, measured in pounds per gallon added (ppa) may be at least about 2 ppa, or at least about 8 ppa, or at least about 12 ppa, or at least about 16 ppa. The proppant transport ability of a base fluid depends on the type of viscosifying additives added to the water base.

In some embodiments, water-base fracturing fluids may have water-soluble polymers added thereto in order to make a viscosified solution to be used during the hydraulic fracturing operation. These water-base fracturing fluids may comprise at least one of guar gums, guar derivatives such as hydroxypropyl guar (HPG), carboxymethyl guar (CMG), carboxymethylhydroxypropyl guar (CMHPG), high-molecular weight polysaccharides composed of mannose and galactose sugars, hydroxylethylcellulose (HEC), hydroxypropylcellulose (HPC) and carboxymethylhydroxyethylcellulose (CMHEC). Additionally, xanthan gum and scleroglucan, two biopolymers, have been shown to have excellent proppant-suspension ability even though they are more expensive than guar derivatives and therefore used less frequently. Polyacrylamide and polyacrylate polymers and copolymers may be used for high-temperature applications or friction reducers at low concentrations for all temperatures ranges. Crosslinking agents based on boron, titanium, zirconium or aluminum complexes may also be used to increase the effective molecular weight of the polymer and make them better suited for use in high-temperature wells.

In some embodiments, polymer-free water-base fracturing fluids containing viscoelastic surfactants may be used during a hydraulic fracturing operation. These fluids are normally prepared by mixing in appropriate amounts of suitable surfactants such as anionic, cationic, nonionic and zwitterionic surfactants. The viscosity of viscoelastic surfactant fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

### EXAMPLES

### Example 1

In order to investigate the influence of intergranular friction, several proppants with different friction coefficients were subjected to a load. The proppants were 20 mesh sand (Roundess 0.69, Sphericity 0.74, angle of repose 42°), 20/40 BoroPropp (Roundess 0.86, Sphericity 0.75, angle of repose 34°), Santrol SHS 20/40 Bauxite (Roundess 0.89, Sphericity 0.86, angle of repose 27°) and Carbo HSP 20/40 (Roundess 0.80, Sphericity 0.87, angle of repose 30°). The same initial volume of proppant was used and the sample dimensions initially were: 20 mm diameter and 6.2 mm height. A load of 45,000 pounds was applied and final sample diameter was measured. FIG. 4 shows the results for each sample after application of the load.

The results show that the material with the highest intergranular friction and with the lowest sphericity/angularity numbers had the smallest pillar after the application of the load with a 33.5 mm diameter. In contrast, Santrol SHS 20/40 Bauxite, the material with the lowest intergranular friction and with high sphericity/angularity numbers had the largest pillar diameter at 49 mm. The low intergranular friction coefficient and high sphericity/angularity numbers for the Santrol SHS 20/40 Bauxite proppant may be explained by the resin coating.

### Example 2

In order to investigate the influence of a proppant materials composition on a channel's width two samples were investigated. The first sample was 50 grams of a slurry of YF140 gel with 20 ppa PolarProp 16/30 and a High Aspect Ratio Proppant (HARP) at 2:1 by weight (PolarProp:HARP) mixed with 5 grams of Carbo HSP 30/60. A sample with the initial dimensions of 8 mm in height and 35 mm in diameter was formed and a load of 45,000 pounds was applied, yielding a sample with a final thickness of 3.9 mm.

The second sample was 50 grams of a slurry of YF140 gel with 20 ppa PolarProp 16/30 and HARP at 2:1 by weight (PolarProp:HARP) mixed with 10 grams of Carbo HSP 30/60 and 10 grams of 100 mesh sand. A sample with the initial dimensions of 8 mm in height and 35 mm in diameter was formed and a load of 45,000 pounds was applied, yielding a sample with a final thickness of 4.9 mm. The results show that an increase in the solid volume fraction of the sample leads to an increase in thickness of the proppant pillar and an increase in the width of the propped fracture.

### Example 3

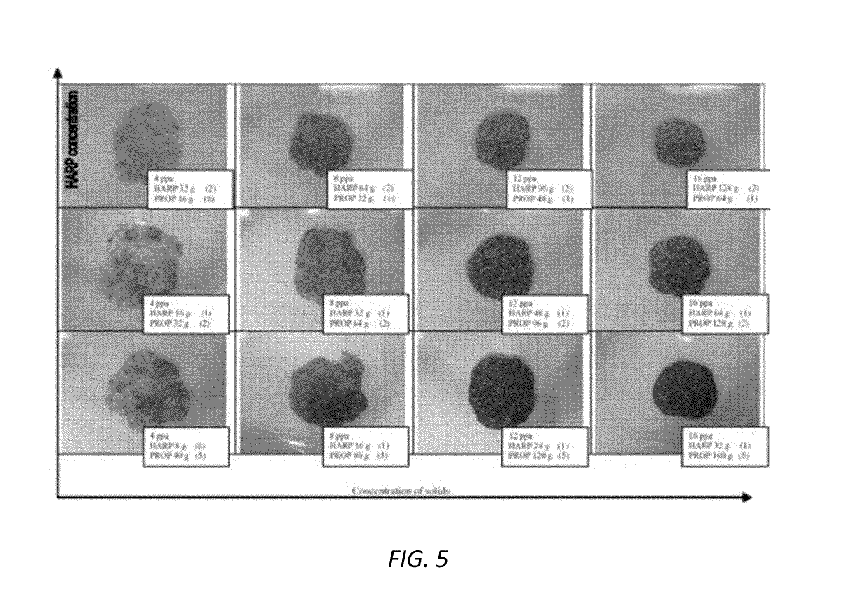

FIG. 5 shows the results of a squashing experiment using a HARP-proppant mixture. The samples shown in the figure were prepared with a combination of YF140 gel and a 20/40 mesh BoroPropp and HARP mixture. The increase in solid concentration is shown on the x-axis of FIG. 5, while on the y-axis the increase in HARP concentration relative to proppant concentration is shown. From comparison of the samples shown in FIG. 5 it can be seen that an increase in solid concentration and an increase in HARP concentration leads to a sample thickness increase and thereby a footprint decrease.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of proppant placement within a fracture, comprising:
injecting a proppant-laden fluid through the wellbore into the fracture under pressure to form at least one proppant pillar within the fracture, the proppant-laden fluid comprising a non-spherical proppant possessing at least some roughness or at least some roughness and angularity;
wherein upon removal of the pressure the diameter of the proppant pillar increases by less than about 100 percent of the initial diameter.

2. The method of claim 1, wherein a portion of the proppant has a sphericity less than about 0.8.

3. The method of claim 2, wherein substantially all of the proppant has a sphericity less than about 0.8.

4. The method of claim 1, wherein a portion of the proppant has a roundness less than about 0.8.

5. The method of claim 4, wherein substantially all of the proppant has a roundness less than about 0.8.

6. The method of claim 1, wherein substantially all of the proppant has a sphericity and roundness less than about 0.7.

7. The method of claim 1, wherein the proppant has a non-uniform size distribution.

8. The method of claim 1, wherein the proppant is coated with a composition that increases inter-proppant friction.

9. The method of claim 1, wherein the proppant-laden fluid further comprises metal or polymeric particles.

10. The method of claim 1, wherein at least a portion of the proppant fragments at stresses lower than the in-situ stress of the formation.

11. The method of claim 1, wherein at least a portion of the proppant is a non-synthetic material selected from at least one of ground or crushed shells of nuts including walnut, coconut, pecan, almond, ivory nut, brazil nut, ground or crushed seed shells or fruit pits including plum, olive, peach, cherry, apricot, processed wood materials including those derived from woods such as oak, hickory, walnut and poplar.

12. A fluid for use in hydraulic fracturing, comprising:
a carrier fluid; and
a non-spherical proppant material that possesses at least some roughness or at least some roughness and angularity.

13. The fluid of claim 12, wherein a portion of the proppant has a sphericity less than about 0.8.

14. The fluid of claim 13, wherein substantially all of the proppant has a sphericity less than about 0.8.

15. The fluid of claim 12, wherein a portion of the proppant has a roundness less than about 0.8.

16. The fluid of claim 15, wherein substantially all of the proppant has a roundness less than about 0.8.

17. The fluid of claim 12, wherein substantially all of the proppant has a sphericity and roundness less than about 0.7.

18. The fluid of claim 12, wherein the proppant has a non-uniform size distribution.

19. The fluid of claim 12, wherein the fluid further comprises metal or polymeric particles.

20. The fluid of claim 12, wherein at least a portion of the proppant fragments at stresses lower than the in-situ stress of the formation.
